(19) United States
(12) Patent Application Publication
(10) Pub. No.: US 2019/0337082 A1
(43) Pub. Date: Nov. 7, 2019

(54) ARC-POINT ADJUSTMENT ROD ATTACHMENT STRUCTURE, ARTICULATED WELDING ROBOT, AND WELDING DEVICE

(71) Applicant: Kabushiki Kaisha Kobe Seiko Sho (Kobe Steel, Ltd.), Kobe-shi (JP)

(72) Inventors: Yasuharu SAKURAI, Fujisawa-shi (JP); Yuki SHIKA, Ibaraki-shi (JP); Motoaki MURAKAMI, Fujisawa-shi (JP); Taichi IGARASHI, Fujisawa-shi (JP); Tatsuji MlNATO, Fujisawa-shi (JP)

(73) Assignee: Kabushiki Kaisha Kobe Seiko Sho (Kobe Steel, Ltd.), Kobe-shi (JP)

(21) Appl. No.: 16/478,502

(22) PCT Filed: Jan. 25, 2018
(86) PCT No.: PCT/JP2018/002351

§ 371 Date: Jul. 17, 2019

(30) Foreign Application Priority Data
Feb. 1, 2017 (JP) 2017-017111

(51) Int. Cl. B23K 9/127

(52) U.S. Cl. CPC B23K 9/1274

(57) ABSTRACT

An arc-point adjustment rod attachment structure includes: a torch support part that includes a base-end-side attachment part which is fixed to a robot distal-end shaft part of an articulated welding robot, and that supports a welding torch; and an adjustment rod attachment part that is disposed on the welding torch side of the base-end-side attachment part, and that detachably supports the arc-point adjustment rod.

### TECHNICAL FIELD

The present invention relates to an arc-point adjustment rod attachment structure, an articulated welding robot, and a welding device.

### BACKGROUND ART

For example, an articulated welding robot configured to perform arc welding includes one provided with a welding torch as described in Patent Document 1. In this articulated welding robot, when the welding torch is attached to a robot arm, an arc point needs to be adjusted such that a tip end of the welding torch reaches a welding point in a robot control system. The method for adjusting the arc point includes, for example, a method using an arc-point adjustment rod. As illustrated in FIG. 8, an arc-point adjustment rod 91 includes a round rod having a position determination section 91a whose tip end is formed in a semicircular sectional shape. The arc-point adjustment rod 91 is supported by a robot arm 92 in such a manner that a base end 91b is inserted into a support hole 93a formed at a tip end shaft portion 93 of the robot arm 92. In a state in which the base end 91b of the arc-point adjustment rod 91 is supported by the support hole 93a, a not-shown cross mark provided at the position determination section 91a indicates an arc point. Position determination is performed by adjustment mechanisms 96, 97 such that a tip end of a welding wire 95 protruding from a welding torch 94 is positioned at the cross mark.

### CITATION LIST

### Patent Document

Patent Document 1: JP 2010-227947 A

### SUMMARY OF THE INVENTION

### Problem to be Solved by the Invention

The arc-point adjustment rod 91 is sometimes arranged across a length L of 500 to 600 mm from the pivot center of the tip end shaft portion 93 of the robot arm 92. For this reason, a relatively-long hole length La is necessary for obtaining support strength, and the axial length Lb of the tip end shaft portion 93 of the robot arm 92 is inevitably extended. Thus, a load on a robot arm side becomes greater due to a tip-end-side member supported by the robot arm 92, and when the robot arm is driven in welding, vibration of the welding torch becomes greater. As a result, it is sometimes difficult to operate the welding robot with high accuracy.

An object of the present invention is to provide an arc-point adjustment rod attachment structure, an articulated welding robot, and a welding device configured so that vibration of a welding torch in welding can be reduced and high-accuracy welding operation can be realized.

### Solution to the Problem

One aspect of the present invention is an arc-point adjustment rod attachment structure for attaching, in an articulated welding robot configured such that a welding torch is connected to a tip end portion of a robot arm, an arc-point adjustment rod including a marker representing an arc point of the welding torch at one end portion to the robot arm, the arc-point adjustment rod attachment structure including a torch support portion having a base-end-side attachment portion fixed to a robot tip end shaft portion of the articulated welding robot and supporting the welding torch and an adjustment rod attachment portion provided on a welding torch side of the base-end-side attachment portion and detachably supporting the arc-point adjustment rod.

According to the arc-point adjustment rod attachment structure, the arc-point adjustment rod is, through the adjustment rod attachment portion, attached to the welding torch side of the base-end-side attachment portion fixed to the tip end shaft portion of the robot arm. Thus, the tip end shaft portion of the robot arm is not an arc-point adjustment rod attachment spot, and therefore, an axial length can be shortened accordingly. Thus, a load on a robot arm side due to a tip-end-side member supported by the robot arm can be reduced. Moreover, the weight of the welding robot tip end shaft portion can be reduced, and vibration of the robot arm in welding can be reduced.

The adjustment rod attachment portion is preferably provided with a hole for supporting a base end portion of the arc-point adjustment rod.

According to the arc-point adjustment rod attachment structure, the arc-point adjustment rod can be, with a simple configuration, supported by the adjustment rod attachment portion.

The adjustment rod attachment portion is preferably configured such that the hole is formed at the center of the robot tip end shaft portion.

According to the arc-point adjustment rod attachment structure, even when the robot tip end shaft portion rotates, the arc-point adjustment rod is less wobbled, and high-accuracy arc-point adjustment is performed.

The adjustment rod attachment portion is preferably detachably supported by the base-end-side attachment portion.

According to the arc-point adjustment rod attachment structure, the adjustment rod attachment portion is detachable from the base-end-side attachment portion. Thus, the weight of the tip end shaft portion of the robot arm can be further reduced, and vibration of the robot arm in welding can be reduced.

The adjustment rod attachment portion preferably includes a laser light source section configured to irradiate a tip end portion of the arc-point adjustment rod with laser light.

According to the arc-point adjustment rod attachment structure, it can be easily checked whether or not the supported arc-point adjustment rod is curved.

A laser sensor unit including a laser light irradiation section configured to irradiate the arc point with laser light and a return light detection section configured to detect return light of the laser light from the arc point is preferably provided at the adjustment rod attachment portion.

According to the arc-point adjustment rod attachment structure, a reference arc point as a reference can be adjusted to an actual arc point.

Moreover, one aspect of the present invention is an articulated welding robot including the above-described arc-point adjustment rod attachment structure.

According to the articulated welding robot, the arc-point adjustment rod is, through the adjustment rod attachment portion, attached to the torch side of the torch support portion provided at the tip end portion of the robot arm. Thus, the axial length of the arc-point adjustment rod attachment spot of the torch support portion is shortened, and weight reduction is realized.

Further, one aspect of the present invention is a welding device including an articulated welding robot having the arc-point adjustment rod attachment structure with the above-described laser sensor unit and a control device configured to drive the robot arm of the articulated welding robot,

the control device driving the robot arm with a reference arc-point position determined by the laser sensor unit being taken as a reference point.

According to the welding device, the articulated welding robot can be driven with high accuracy with the reference arc-point position determined by the laser sensor unit being taken as the reference point.

### Advantageous Effects of the Invention

According to the present invention, vibration of the welding torch in welding can be reduced, and high-accuracy welding operation can be realized.

### BRIEF DESCRIPTION OF DRAWINGS

FIG. 1 is a schematic view of an entire configuration of a welding device.

FIG. 2 is a perspective view of an outer appearance of one example of an articulated welding robot.

FIG. 3 is a side view of a first configuration example of an arc-point adjustment rod attachment structure.

FIG. 4 is a side view of an arc-point adjustment rod.

FIG. 5 is a side view of a second configuration example of the arc-point adjustment rod attachment structure.

FIG. 6 is a side view of a third configuration example of the arc-point adjustment rod attachment structure.

FIG. 7 is an enlarged perspective view of a torch support portion of a fourth configuration example in which a weaving device is mounted on the articulated welding robot.

FIG. 8 is a side view of a typical arc-point adjustment rod attachment structure.

### DESCRIPTION OF EMBODIMENTS

Hereinafter, an embodiment of the present invention will be described in detail with reference to the drawings.

<Entire Configuration of Welding Device>

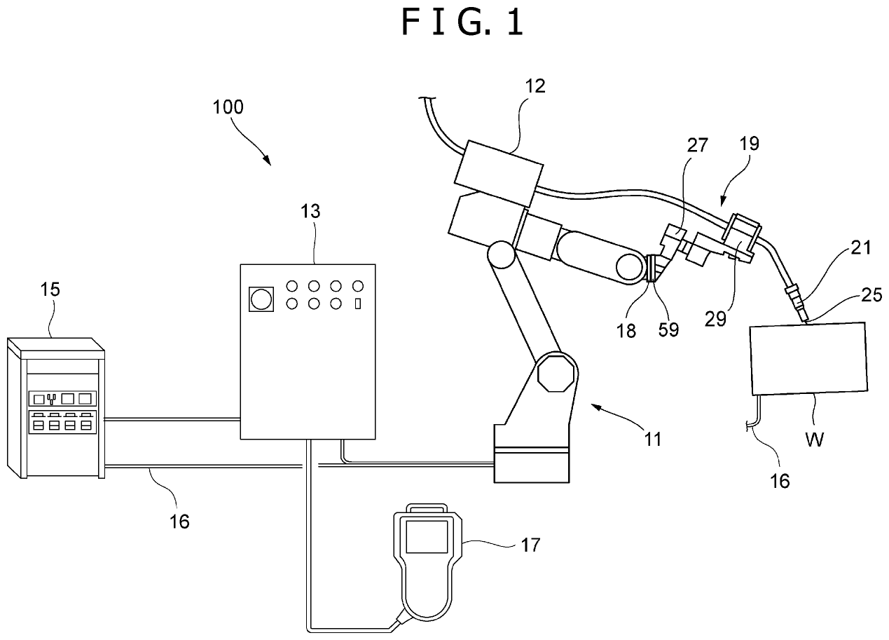

FIG. 1 is a schematic view of an entire configuration of a welding device 100.

The welding device 100 includes an articulated welding robot 11, a control device 13, a welding power source 15, and a teaching controller 17. A torch support portion 19 as an end effector is connected to a robot tip end shaft portion 18 of the articulated welding robot 11. As in an illustrated example, the torch support portion 19 has a welding torch 21 at a tip end portion, and includes adjustment mechanisms 27, 29 configured to adjust a tip end position of the welding torch 21. Note that in addition to the torch support portion 19 for supporting the welding torch 21, other tools such as a cutting machine having a cutting torch may be used as the end effector.

The control device 13 drives the articulated welding robot 11 based on teaching data input from the teaching controller 17 to move the welding torch 21. Various drive programs are stored in a not-shown storage section such as a ROM, a RAM, or a hard drive, and the control device 13 reads and executes the drive program to perform drive control for each section of the welding device 100.

A welding wire 25 as a consumable electrode, such as a flux cored wire or a solid wire, is supplied to the tip end of the welding torch 21. The welding wire 25 is reeled out of a not-shown wire pack by a wire feed device 12. The welding power source 15 is connected to the welding torch 21 and a work W through a power supply cable 16. According to a command from the control device 13, welding current is supplied to the welding torch 21 through a power cable arranged in the articulated welding robot 11. Moreover, shield gas is supplied to the welding torch 21 to provide protection from entrapment of atmospheric air in welding. Further, cooling water for torch cooling is also supplied to the welding torch 21.

<First Configuration Example>

Next, a first configuration example of an arc-point adjustment rod attachment structure in the articulated welding robot 11 having the above-described configuration will be described in detail.

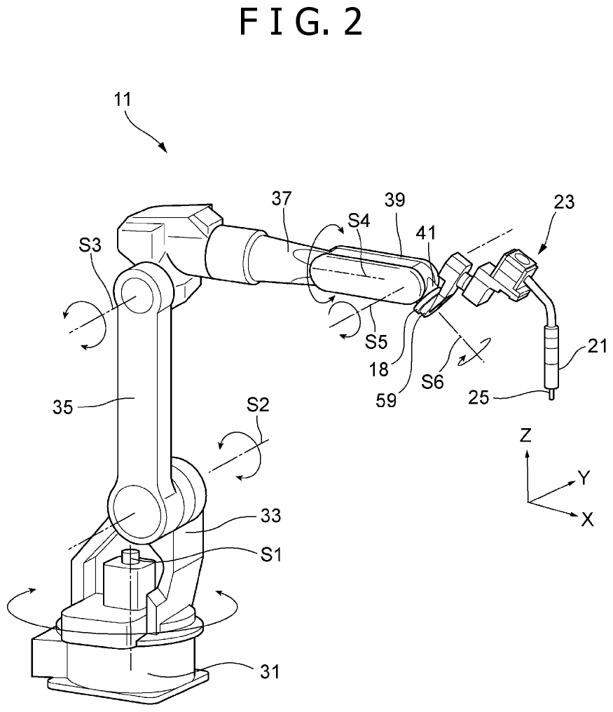

FIG. 2 is a perspective view of an outer appearance of one example of the articulated welding robot 11.

The articulated welding robot 11 includes, for example, a typical six-axis robot having six drive shafts. An illustrated example shows an articulated welding robot capable of performing rotation operation about drive shafts S1 to S6. In addition to the six-axis robot, the articulated welding robot 11 may be, for example, a seven-axis robot or multiaxial robots having other configurations. Hereinafter, the articulated welding robot 11 will be abbreviated as a “robot.”

The robot 11 includes a base 31, a pivoting portion 33 provided pivotably about the first drive shaft S1 on the base 31, a lower arm 35 having one end portion coupled to the pivoting portion 33 through the second drive shaft S2 and provided rotatably about the second drive shaft S2, an upper arm 37 connected to the other end portion of the lower arm 35 through the third drive shaft S3, a wrist pivoting portion 39 provided at the upper arm 37 and provided rotatably about an arm axis by the fourth drive shaft S4, a wrist bending portion 41 connected to the wrist pivoting portion 39 through the fifth drive shaft S5, and the above-described robot tip end shaft portion (a wrist rotation portion) 18 connected to a tip end of the wrist bending portion 41 and having the sixth drive shaft S6. The lower arm 35, the upper arm 37, the wrist pivoting portion 39, the wrist bending portion 41, and the robot tip end shaft portion 18 form an articulated arm.

The first drive shaft S1 to the sixth drive shaft S6 of the robot 11 are driven by not-shown drive motors such as servomotors. A drive signal is input from the control device 13 (see FIG. 1) to each of these drive motors such that the rotation angle of each drive shaft is controlled. Accordingly, the welding torch 21 can be position-determined in a desired posture in an XYZ space.

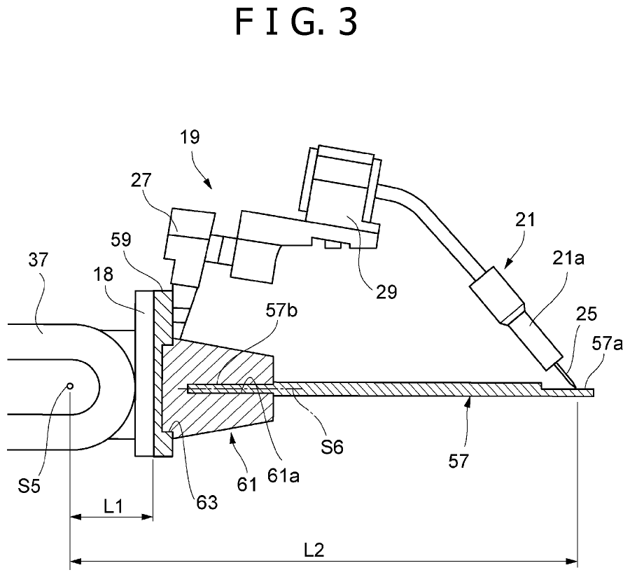

FIG. 3 is a side view of the first configuration example of the arc-point adjustment rod attachment structure.

A base-end-side attachment portion 59 formed on a base end side of the torch support portion 19 is fixed to the robot tip end shaft portion 18. The base-end-side attachment portion 59 is configured such that one end side of the base-end-side attachment portion 59 is fixed to the robot tip end shaft portion 18 with, e.g., a not-shown bolt and the adjustment mechanisms 27, 29 configured to movably support the welding torch 21 are provided to extend from part of an outer peripheral portion of the base-end-side attachment portion 59. The adjustment mechanisms 27, 29 include direct acting sliders. On a welding torch 21 side as the other end side of the base-end-side attachment portion 59, an adjustment rod attachment portion 61 for supporting an arc-point adjustment rod 57 concentrically with the center of the sixth drive shaft S6. The arc-point adjustment rod 57 is detachably attached to the adjustment rod attachment portion 61. A tip end portion 57a of the arc-point adjustment rod 57 is, for example, used for adjustment of a welding position, and is detached in welding.

The adjustment rod attachment portion 61 is in such a shape that the outer diameter of the adjustment rod attachment portion 61 is gradually narrowed toward a torch tip end side. In addition to the configuration in which the adjustment rod attachment portion 61 is detachable from the base-end-side attachment portion 59, the adjustment rod attachment portion 61 may be configured integrally with the base-end-side attachment portion 59. The adjustment rod attachment portion 61 in an illustrated example is configured such that an engaging portion 63 configured to engage with the base-end-side attachment portion 59 is formed at one end portion (the left side in FIG. 3), and is detachably attached to the base-end-side attachment portion 59. A well-known engagement mechanism such as fastening with a screw, interference fit, or fixing with an elastically-deformable locking claw is applicable to the engaging portion 63.

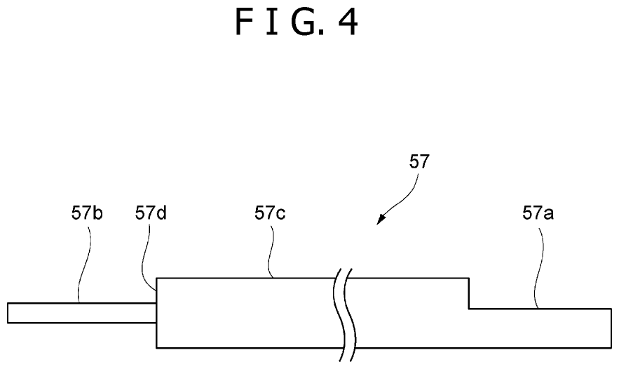

FIG. 4 is a side view of the arc-point adjustment rod 57.

The arc-point adjustment rod 57 is entirely in the form of a linear rod body, the tip end portion 57a having a semicircular section and a base end portion 57b and a main body portion 57c having a circular section. Moreover, the base end portion 57b has a narrower diameter than that of the main body portion 57c . Although not shown in the figure, a marker representing an arc-point position, such as a cross mark, is provided at a planar portion formed along an axial direction at the tip end portion 57a having the semicircular section.

As illustrated in FIG. 3, the adjustment rod attachment portion 61 is configured such that a hole 61a for supporting the base end portion 57b of the arc-point adjustment rod 57 is formed on the other end side (the right side in FIG. 3) as a side facing the welding torch 21 on the opposite side of the base-end-side attachment portion 59. The hole 61a is formed at the center of the sixth drive shaft S6 such that the arc-point adjustment rod 57 is supported on the same axis as that of the sixth drive shaft S6. The base end portion 57b of the arc-point adjustment rod 57 is inserted into the hole 61a. When the arc-point adjustment rod 57 is pushed in to such a position that a base-end-side step portion 57d (see FIG. 4) contacts the adjustment rod attachment portion 61, the position of the marker of the tip end portion 57a is at a position indicating a regular arc point. A tip end of the welding wire 25 protruding from the welding torch 21 is adjusted to this arc point such that a reference position of the welding torch 21 is adjusted.

After adjustment of the reference position of the welding torch 21 has been completed using the arc-point adjustment rod 57, the arc-point adjustment rod 57 is detached from the adjustment rod attachment portion 61 by pulling out. Accordingly, the welding torch 21 is brought into a weldable state. In addition to detachment of only the arc-point adjustment rod 57, the arc-point adjustment rod 57 and the adjustment rod attachment portion 61 may be detached together.

According to the arc-point adjustment rod attachment structure of the present configuration, the base-end-side attachment portion 59 of the torch support portion 19 is fixed to the robot tip end shaft portion 18, and the adjustment rod attachment portion 61 and the arc-point adjustment rod 57 are arranged on the welding torch 21 side of the base-end-side attachment portion 59. Thus, the arc-point adjustment rod 57 is supported by the adjustment rod attachment portion 61, and therefore, does not enter a robot tip end shaft portion 18 side beyond the base-end-side attachment portion 59.

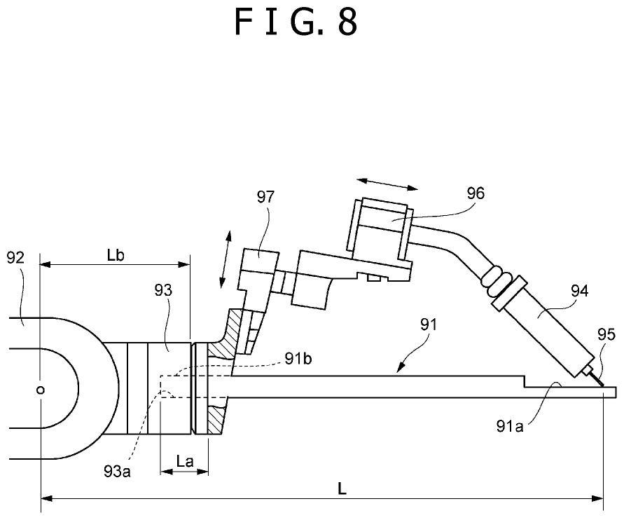

That is, the arc-point adjustment rod 57 is arranged only on the side of the base-end-side attachment portion 59 facing the welding torch 21, and therefore, a distance L1 from the fifth drive shaft S5 to the base-end-side attachment portion 59 of the robot 11 can be shortened as compared to a distance Lb in a typical configuration (see FIG. 8). Thus, a load on a robot arm tip end portion on the welding torch 21 side with respect to the robot tip end shaft portion 18 can be reduced. Consequently, unexpected vibration of the welding torch 21 due to operation of each drive shaft of the robot 11 in welding can be reduced. Moreover, unnecessary vibration of the welding torch 21 is reduced. Thus, welding along a preset welding line can be performed with high position accuracy, and high-quality welding can be realized. Specifically, e.g., weaving operation can be performed with high accuracy. Specifically, the above-described advantageous effect becomes more noticeable as a distance L2 from the fifth drive shaft S5 to the tip end of the welding torch 21 increases and the weight of the torch support portion 19 of the adjustment mechanisms 27, 29 increases.

When welding is performed with the arc-point adjustment rod 57 being detached, the adjustment rod attachment portion 61 remains. In the case of detaching only the arc-point adjustment rod 57, the process of detaching and re-attaching the arc-point adjustment rod 57 can be more easily performed.

### Second Configuration Example

Next, a second configuration example of the arc-point adjustment rod attachment structure will be described.

In description below, the same reference numerals are used to represent the same members or sections as those of the first configuration example illustrated in FIGS. 3 and 4, and therefore, description thereof will be simplified or omitted.

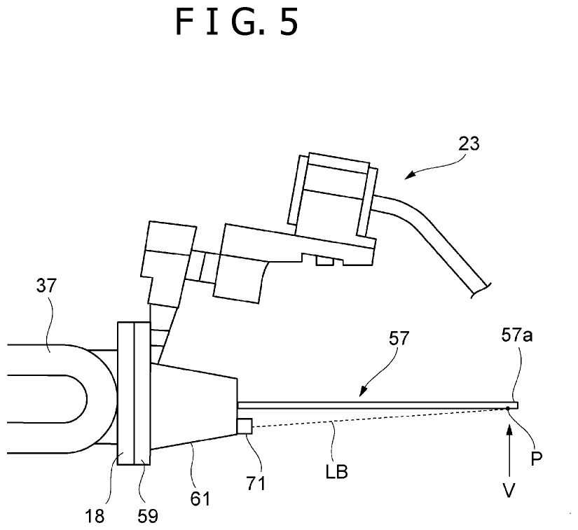

FIG. 5 is a side view of the second configuration example of the arc-point adjustment rod attachment structure.

The arc-point adjustment rod attachment structure of the present configuration includes, on the welding torch 21 side of the adjustment rod attachment portion 61 having the structure illustrated in FIG. 3, a laser light source section 71 configured to irradiate the tip end portion 57a of the arc-point adjustment rod 57 with laser light LB.

The laser light source section 71 irradiates, with a laser spot P of the laser light LB, the tip end portion 57a of the arc-point adjustment rod 57 attached to the adjustment rod attachment portion 61. Then, when viewed by an operator in a V-direction in the figure, if the position of the laser spot P and the position of the marker provided at the tip end portion 57a are coincident with each other, a normal state without, e.g., curvature of the arc-point adjustment rod 57 can be confirmed. In a case where the laser spot P and the marker are shifted from each other, the arc-point adjustment rod 57 is adjusted to bring both positions into a coincident state, or the arc-point adjustment rod 57 is replaced with a new one.

According to the arc-point adjustment rod attachment structure of the present configuration, reliability of the arc-point position by the arc-point adjustment rod 57 can be easily ensured by visual checking of the laser spot P. The arc-point adjustment rod 57 in this case may or may not include the planar portion with the semicircular section at the tip end portion 57a.

### Third Configuration Example

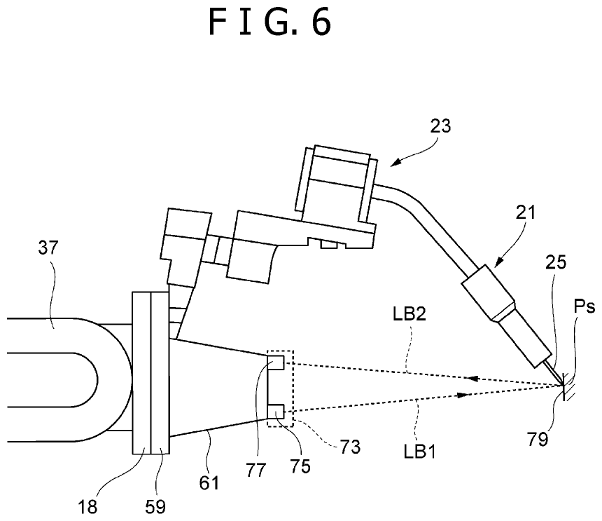

FIG. 6 is a side view of a third configuration example of the arc-point adjustment rod attachment structure.

The arc-point adjustment rod attachment structure of the present configuration is configured such that a laser sensor unit 73 is attached to the welding torch 21 side of the adjustment rod attachment portion 61 having the structure illustrated in FIG. 3.

The laser sensor unit 73 has a laser light irradiation section 75 configured to irradiate an arc point Ps with laser light LB1, and a return light detection section 77 configured to detect return light LB2 of the laser light from the arc point Ps. The laser sensor unit 73 is connected to a not-shown distance calculation section configured to obtain a distance from the laser sensor unit 73 to the arc point Ps based on a relationship between the laser light LB1 and the return light LB2.

In the illustrated example, an optional wall surface 79 contacting the tip end of the welding wire 25 is irradiated with the laser light LB1 from the laser light irradiation section 75, and the return light LB2 from the wall surface 79 is detected. The distance calculation section obtains a distance from the laser sensor unit 73 to the wall surface 79 based on the relationship between the laser light LB1 and the return light LB2 by, e.g., a well-known phase-contrast method, and outputs such distance information. The distance information output from the distance calculation section is input to the control device 13 illustrated in FIG. 1. According to the input distance information, the control device 13 drives the articulated welding robot 11 such that a distance corresponding to a preset reference arc-point position is brought, i.e., a tip end position of the welding wire 25 of the welding torch 21 becomes coincident with the reference arc-point position. Accordingly, a reference point in-driving of the robot 11 is set.

In addition to reflection of the laser light LB1 on the wall surface 79, reflected light from the welding wire 25 itself may be measured as the return light LB2 in some cases.

According to the arc-point adjustment rod attachment structure of the present configuration, the position of the welding torch 21 is adjusted such that the preset reference arc-point position reaches an actual arc point. Thus, the welding torch 21 can be position-determined at an accurate arc-point position.

In the above-described manner, the control device 13 drives the welding torch 21 with the reference arc-point position determined by the laser sensor unit 73 being taken as a reference drive point.

After such adjustment, the arc-point adjustment rod 57 is attached to the adjustment rod attachment portion 61, and the set reference arc-point position and the arc-point position by the arc-point adjustment rod as described above are compared with each other. In a case where these positions are shifted from each other, the arc-point adjustment rod is adjusted. Accordingly, reliability of the arc-point adjustment rod can be ensured.

In addition to movement of the welding torch 21 to the arc-point position and setting of the reference point in driving of the robot 11 as described above, the drive program may be corrected to adjust the reference point. For example, when a robot arm is driven based on the drive program prepared in advance, the control device 13 obtains a difference between a current robot reference point (before correction) and the reference arc-point position such that the reference arc-point position reaches the reference point in driving, and changes a parameter of the drive program, such as a coordinate value, according to such a difference. Then, the control device 13 drives the robot arm according to the changed parameter. With this configuration, accurate welding based on the reference arc-point position can be also realized.

### Fourth Configuration Example

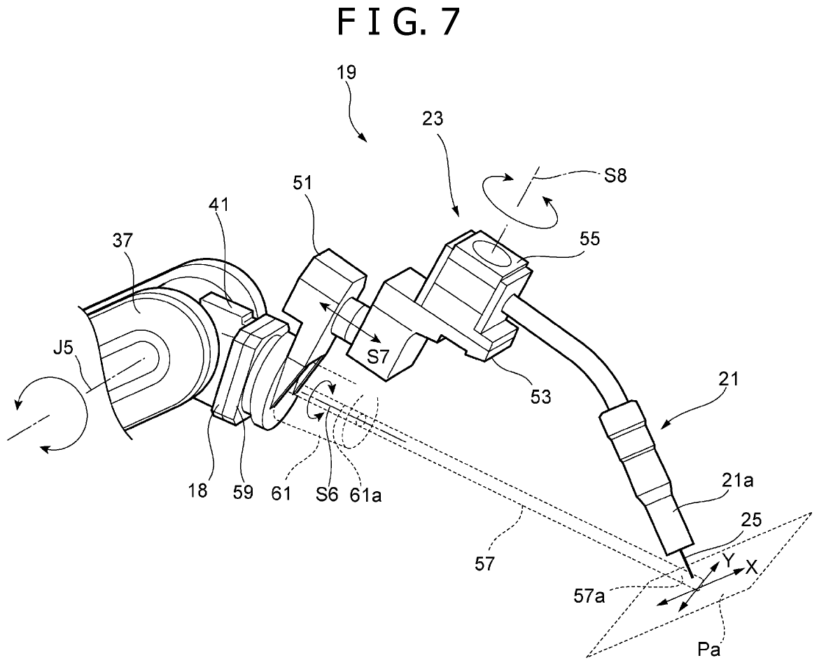

Next, a fourth configuration example will be described. FIG. 7 is an enlarged perspective view of the welding torch 21 when a two-axis weaver 23 is provided at the robot tip end shaft portion 18 of the robot 11 having the above-described configuration.

The two-axis weaver 23 includes a drive section configured to move the welding torch 21 relative to the robot tip end shaft portion 18 along two axes perpendicular to each other. The weaving operation is performed by swing drive of the welding torch 21 by the drive section.

The two-axis weaver 23 is connected to the robot tip end shaft portion 18 of the robot 11 to drive in two directions on a plane Pa about a torch tip end shaft 21a. The two-axis weaver 23 has a first drive section 51 to be driven in an X-axis direction, the torch tip end shaft 21a, and a second drive section 53 to be driven in a Y-direction perpendicular to the X-direction. The first drive section 51 and the second drive section 53 are, about the reference arc-point position on the torch tip end shaft 21a, driven in two directions perpendicular to each other on the plane Pa.

The first drive section 51 has a direct acting slide unit configured to move the second drive section 53 along a movement direction as the X-direction (S7). The second drive section 53 has a rotation unit configured to rotatably support a torch base portion 55 supporting the welding torch 21 about an eighth drive shaft S8.

According to the robot 11 equipped with the two-axis weaver 23 having the above-described configuration, the arc point is position-determined with high accuracy, and therefore, high-accuracy weaving operation is realized.

Note that in the above-described first to third configuration examples, the weaving operation by the two-axis weaver 23 described in the fourth configuration example can be realized in such a manner that the control device 13 drivably controls each drive shaft of the robot 11. In this case, high position determination accuracy is required for the robot 11. However, the reference arc-point position is accurately set, and therefore, high-accuracy welding can be realized.

The present invention is not limited to the above-described embodiment. The present invention also includes combinations of the configurations of the embodiment and changes and applications made based on description of the specification and well-known techniques by those skilled in the art, and these combinations, changes, and applications are included in the scope of protection sought.

The present application is based on a Japanese patent application (Japanese Patent Application No. 2017-17111) filed Feb. 1, 2017, the disclosure of which is incorporated herein by reference.

### EXPLANATION OF REFERENCE NUMERALS

11 robot (articulated welding robot)
18 robot tip end shaft portion
19 torch support portion
21 welding torch
55 torch base portion
57 arc-point adjustment rod
57a tip end portion
57b base end portion
59 base-end-side attachment portion
61 adjustment rod attachment portion
61a hole
63 engaging portion
71 laser light source section
73 laser sensor unit
75 laser light irradiation section
77 return light detection section
100 welding device

1. An arc-point adjustment rod attachment structure for attaching, in an articulated welding robot configured such that a welding torch is connected to a tip end portion of a robot arm, an arc-point adjustment rod including a marker representing an arc point of the welding torch at one end portion to the robot arm, comprising:
a torch support portion having a base-end-side attachment portion fixed to a robot tip end shaft portion of the articulated welding robot and supporting the welding torch; and
An adjustment rod attachment portion provided on a welding torch side of the base-end-side attachment portion and detachably supporting the arc-point adjustment rod.

2. The arc-point adjustment rod attachment structure according to claim 1, wherein
the adjustment rod attachment portion is provided with a hole for supporting a base end portion of the arc-point adjustment rod.

3. The arc-point adjustment rod attachment structure according to claim 2, wherein
the adjustment rod attachment portion is configured such that the hole is formed at a center of the robot tip end shaft portion.

4. The arc-point adjustment rod attachment structure according to claim 1, wherein
the adjustment rod attachment portion is detachably supported by the base-end-side attachment portion.

5. The arc-point adjustment rod attachment structure according to claim 1, wherein
the adjustment rod attachment portion includes a laser light source section configured to irradiate a tip end portion of the arc-point adjustment rod with laser light.

6. The arc-point adjustment rod attachment structure according to claim 4, wherein
the adjustment rod attachment portion includes a laser light source section configured to irradiate a tip end portion of the arc-point adjustment rod with laser light.

7. The arc-point adjustment rod attachment structure according to claim 1, wherein
a laser sensor unit including a laser light irradiation section configured to irradiate the arc point with laser light and a return light detection section configured to detect return light of the laser light from the arc point is provided at the adjustment rod attachment portion.

8. The arc-point adjustment rod attachment structure according to claim 4, wherein
a laser sensor unit including a laser light irradiation section configured to irradiate the arc point with laser light and a return light detection section configured to detect return light of the laser light from the arc point is provided at the adjustment rod attachment portion.

9. An articulated welding robot comprising:
the arc-point adjustment rod attachment structure according to claim 1.

10. A welding device comprising:
an articulated welding robot including the arc-point adjustment rod attachment structure according to claim 7; and
a control device configured to drive the robot arm of the articulated welding robot,
wherein the control device drives the robot arm with a reference arc-point position determined by the laser sensor unit being taken as a reference point.
